(19) United States
(12) Patent Application Publication
(10) Pub. No.: US 2023/0266719 A1
(43) Pub. Date: Aug. 24, 2023

(54) INFORMATION PROCESSING DEVICE AND FUNCTION GENERATION METHOD

(71) Applicant: Fujitsu Limited, Kawasaki-shi (JP)

(72) Inventors: Noriyasu ASO, Isehara (JP); Masatoshi OGAWA, Zama (JP)

(73) Assignee: Fujitsu Limited, Kawasaki-shi (JP)

(21) Appl. No.: 18/072,717

(22) Filed: Dec. 1, 2022

(30) Foreign Application Priority Data
Feb. 22, 2022 (JP) 2022-025314

(51) Int. Cl. G05B 13/02

(52) U.S. Cl. CPC G05B 13/021; G05B 13/024; G05B 13/027

(57) ABSTRACT

A non-transitory computer-readable recording medium stores a function generation program for causing a computer to execute a process, the process includes acquiring manipulation data generated based on manipulated variable distribution information that represents distribution of values of manipulated variables, and measurement data measured when a control object device is controlled based on the manipulation data, and by performing inverse reinforcement learning by using the manipulation data and the measurement data, generating a reward function that includes evaluation indices for the manipulated variable distribution information and coefficient distribution information that represents distribution of the values of coefficients of the evaluation indices.

### CROSS-REFERENCE TO RELATED APPLICATION

This application is based upon and claims the benefit of priority of the prior Japanese Patent Application No. 2022-025314, filed on Feb. 22, 2022, the entire contents of which are incorporated herein by reference.

### FIELD

The embodiment discussed herein is related to an information processing device and a function generation method.

### BACKGROUND

Control maps are sometimes used to control automobile engines. The control map represents the distribution of control parameters for controlling the engine and is created for each control parameter.

Automobiles are equipped with a large number of electronics for controlling engines in order to achieve both of driving performance and environmental performance. These electronics are called control equipment or actuators. The driving performance represents the ease of driving, and the environmental performance represents the impact of the exhaust gas from the engine on the environment. The actuators of automobiles are controlled using a large number of control maps created in line with a variety of driving conditions, and these control maps are managed in cooperation between the actuators.

In relation to driving an automobile, there is known an information processing device that utilizes a model adapted to a predetermined system and efficiently adapts the model to another system with a similar environment or agent. There is also known an air-fuel ratio control device that controls the actual air-fuel ratio to approach a target air-fuel ratio, based on the oxygen concentration in the exhaust. There is also known a control device that lowers man-hours of a skilled person involved in regulating the manipulated amount of a manipulation unit of an internal combustion engine.

International Publication Pamphlet No. WO 2020/065808, Japanese Laid-open Patent Publication No. 2012-31747, and Japanese Laid-open Patent Publication No. 2021-124055 are disclosed as related art.

### SUMMARY

According to an aspect of the embodiment, a non-transitory computer-readable recording medium stores a function generation program for causing a computer to execute a process, the process includes acquiring manipulation data generated based on manipulated variable distribution information that represents distribution of values of manipulated variables, and measurement data measured when a control object device is controlled based on the manipulation data, and by performing inverse reinforcement learning by using the manipulation data and the measurement data, generating a reward function that includes evaluation indices for the manipulated variable distribution information and coefficient distribution information that represents distribution of the values of coefficients of the evaluation indices.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram of an engine test rig;

FIGS. 2A and 2B are diagrams illustrating problems in creating a control map;

FIG. 3 is a functional configuration diagram of a function generation device;

FIG. 4 is a flowchart of a function generation process;

FIG. 5 is a functional configuration diagram of a control device;

FIG. 6 is a configuration diagram of an engine control system;

FIG. 7 is a hardware configuration diagram of a control device;

FIG. 8 is a functional configuration diagram of a control unit;

FIG. 9 is a functional configuration diagram of a feedback (FB) control unit;

FIG. 10 is a diagram illustrating n control maps;

FIG. 11 is a diagram illustrating a control map of a manipulated variable ui;

FIGS. 12A and 12B are diagrams illustrating manipulation data and control data;

FIG. 13 is a functional configuration diagram of a server;

FIG. 14 is a diagram illustrating evaluation index data;

FIG. 15 is a diagram illustrating p coefficient maps;

FIG. 16 is a diagram illustrating the coefficient map of a coefficient θk;

FIG. 17 is a flowchart of a control map adjustment process;

FIG. 18 is a configuration diagram of an engine control system provided in an automobile;

FIG. 19 is a functional configuration diagram of a control unit that performs model predictive control; and

FIG. 20 is a hardware configuration diagram of an information processing device.

### DESCRIPTION OF EMBODIMENT

An engineer who creates the control map acquires a large amount of test data by conducting an engine operation test using an engine test rig. Then, the engineer adjusts each control parameter while grasping the dynamic causal relationship between the control parameter of each of a large number of control maps and an evaluation index for the control maps. The control parameter is sometimes also called a manipulated variable.

A control device in an engine test rig is equipped with a large number of actuators. Each actuator controls the operation of the engine by generating a control signal based on manipulation data representing the value of the manipulated variable and outputting the generated control signal to the engine. For this reason, a large number of control maps regarding a large number of manipulated variables are used in the engine operation test.

Since these manipulated variables interfere with each other, it is highly difficult to work on adjusting the values of the manipulated variables included in each control map. Thus, a skilled engineer often adjusts the values of the manipulated variables based on experience and creates a control map. The skilled engineer is sometimes also called an expert.

Based on empirical evaluation criteria, experts consider the driving performance and environmental performance of automobiles and create a control map while considering the interrelationship between a large number of manipulated variables of actuators and an evaluation index, for each of a variety of driving conditions. Since there are many matters to be considered in this manner, creating a control map is an individual-dependent work that depends on the ability of each individual expert.

Meanwhile, it is difficult for inexperienced engineers to create an appropriate control map because the inexperienced engineers do not have experience-based evaluation criteria like the experts.

Note that such a problem arises not only when an automobile engine is controlled but also when various control object devices are controlled. In addition, such a problem arises not only when an expert or an inexperienced engineer creates a control map, but also when various engineers create a control map.

Hereinafter, an embodiment will be described in detail with reference to the drawings.

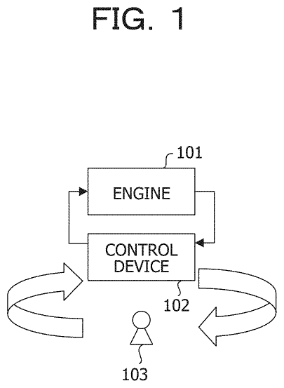

FIG. 1 illustrates a configuration example of an engine test rig. The engine test rig in FIG. 1 includes an engine 101 and a control device 102. An expert 103 sets control maps for each of a large number of manipulated variables in the control device 102.

The control device 102 includes a large number of actuators and performs an operation test of the engine 101 by outputting control signals to the engine 101 based on the set control maps. Then, the control device 102 acquires test data to calculate the value of an evaluation index for the control maps and outputs the calculated value of the evaluation index.

The expert 103 evaluates the value of the evaluation index based on empirical evaluation criteria, adjusts the values of the manipulated variables included in each control map, and sets the adjusted control maps in the control device 102 again. By repeating such adjustments, a control map for the engine to be shipped is created.

The test data acquired in the operation test of the engine 101 includes manipulation data and measurement data. The manipulation data is data that indicates the value of the manipulated variable. For example, a fuel injection quantity, fuel injection pressure, fuel injection timing, exhaust gas recirculation opening, turbo opening, or intake valve opening are used as manipulated variables. These manipulated variables are engine-specific manipulated variables.

The exhaust gas recirculation opening represents the opening of the exhaust gas recirculation (EGR) adjustment valve and is sometimes also called the EGR opening. The turbo opening represents the opening of the variable nozzle of the turbocharger, and the intake valve opening represents the opening of the intake valve.

The measurement data is data that indicates the value of a measurement object variable. The measurement object variables include control variables and environmental performance variables. For example, rotational speed, torque, boost pressure, or intake air flow rate are used as control variables. For example, the concentration of substances contained in the exhaust gas is used as environmental performance variables. Substances contained in the exhaust gas are, for example, nitrogen oxides, soot, carbon monoxide, nitric oxide, carbon dioxide, or hydrocarbons. These control variables and environmental performance variables are engine-specific control variables and environmental performance variables.

As the evaluation index for the control map, an index based on the manipulated variables or the measurement object variables is used. The evaluation index may be, for example, the concentration of substances contained in the exhaust gas, the square of the error between the target value and the measured value of the control variable, the amount of overshoot of the measured value of the control variable relative to the target value, the rising speed of the measured value of the control variable relative to the target value, or the square of the amount of change in the manipulated variable.

Since the creation of the control map by the expert 103 is an individual-dependent work, variations in the quality of the created control map arise. In addition, since the evaluation criteria of the expert 103 are complicated and not formulated, the control map is not automatically adjusted based on the evaluation criteria. Therefore, it takes a long time to evaluate and adjust the control map.

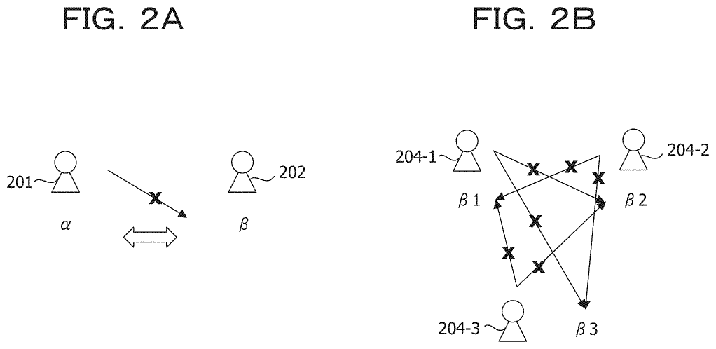

FIGS. 2A and 2B illustrate an example of a problem in creating the control map. FIG. 2A illustrates an example of a problem for an inexperienced engineer. An inexperienced engineer 201 has an evaluation criterion α and an expert 202 has an evaluation criterion β. The evaluation criterion a includes an evaluation index of the engineer 201 for the control map, and the evaluation criterion β includes an evaluation index of the expert 202 for the control map.

In order for the engineer 201 to create an appropriate control map, it is desirable to learn the evaluation criterion β of the expert 202 and reflect the learned evaluation criterion β in the evaluation criterion α. However, since the evaluation criterion β is not visualized, it is difficult for the engineer 201 to, for example, confirm the evaluation criterion β or to compare the evaluation criteria α and β.

FIG. 2B illustrates an example of a problem with a plurality of experts. An expert 204-1 has an evaluation criterion β1, an expert 204-2 has an evaluation criterion β2, and an expert 204-3 has an evaluation criterion β3. However, since the evaluation criteria β1 to β3 are not visualized, it is difficult for each of the experts 204-1 to 204-3 to confirm the evaluation criteria of the other experts. In addition, it is also difficult for the experts 204-1 to 204-3 to share the evaluation criteria β1 to β3.

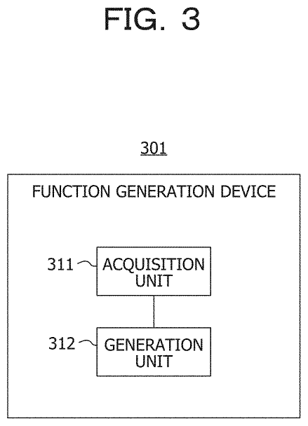

FIG. 3 illustrates a functional configuration example of a function generation device according to the embodiment. A function generation device 301 in FIG. 3 includes an acquisition unit 311 and a generation unit 312.

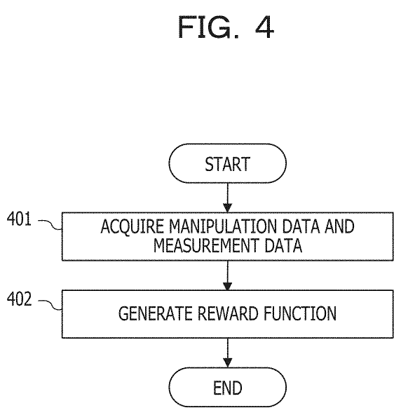

FIG. 4 is a flowchart illustrating an example of a function generation process performed by the function generation device 301 in FIG. 3. First, the acquisition unit 311 acquires manipulation data generated based on manipulated variable distribution information representing distribution of the values of the manipulated variables, and the measurement data measured when the control object device is controlled based on the manipulation data (step 401). Next, by performing inverse reinforcement learning using the manipulation data and the measurement data, the generation unit 312 generates a reward function including evaluation indices for the manipulated variable distribution information, and coefficient distribution information representing distribution of the values of coefficients of the evaluation indices (step 402).

According to the function generation device 301 in FIG. 3, an evaluation criterion when the distribution of the values of the manipulated variables for the control object device is created may be acquired.

The control object devices are industrial products, factory facilities, plants, and the like. The industrial products may be engines for automobiles, aircraft, or ships, and may be robots, electric appliances, or electronics. The factory facilities may be manufacturing devices, transport devices, or monitoring devices. The plants may be a power plant, an oil plant, a chemical plant, a water treatment plant, or a waste treatment plant.

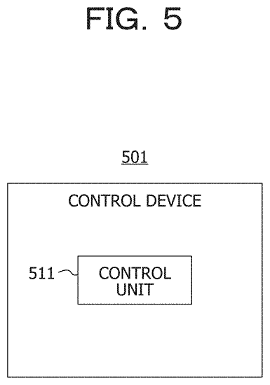

FIG. 5 illustrates a functional configuration example of a control device according to the embodiment. A control device 501 in FIG. 5 includes a control unit 511. The control unit 511 controls a second control object device by model predictive control (MPC) using, as an objective function, the reward function generated by inverse reinforcement learning based on the control result for a first control object device.

The Inverse reinforcement learning is performed using the manipulation data generated based on the manipulated variable distribution information representing distribution of the values of the manipulated variables, and the measurement data measured when the first control object device is controlled based on the manipulation data. The reward function includes evaluation indices for the manipulated variable distribution information, and the coefficient distribution information representing distribution of the values of coefficients of the evaluation indices.

According to the control device 501 in FIG. 5, an evaluation criterion when the distribution of the values of the manipulated variables for the first control object device is created may be acquired and used for controlling the second control object device.

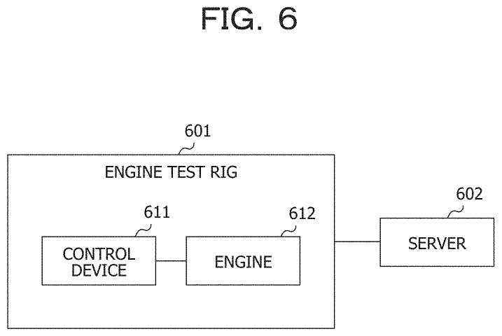

FIG. 6 illustrates a configuration example of an engine control system including the function generation device 301 in FIG. 3. The engine control system in FIG. 6 includes an engine test rig 601 and a server 602, and the engine test rig 601 includes a control device 611 and an engine 612 of an automobile. The server 602 corresponds to the function generation device 301 in FIG. 3, and the engine 612 corresponds to the control object device.

The control device 611 acquires test data by performing an operation test of the engine 612 based on the control map created by an engineer E1 and transmits the acquired test data to the server 602. The engineer E1 is, for example, an expert.

The server 602 generates a reward function including evaluation indices for the control map as variables, using the test data received from the engine test rig 601. The control map corresponds to the manipulated variable distribution information representing distribution of the values of manipulated variables.

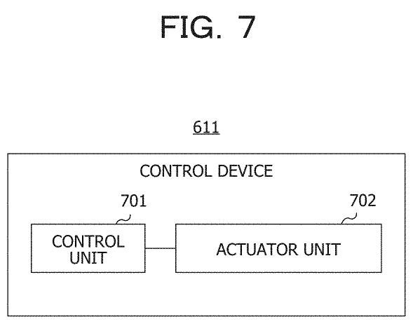

FIG. 7 illustrates a hardware configuration example of the control device 611 in FIG. 6. The control device 611 in FIG. 7 includes a control unit 701 and an actuator unit 702. The control unit 701 and the actuator unit 702 are hardware.

The control unit 701 generates the manipulation data based on the adjusted control map created by the engineer E1 and outputs the generated manipulation data to the actuator unit 702. The actuator unit 702 includes a plurality of actuators. Each actuator converts the manipulation data output from the control unit 701 into a control signal and outputs the control signal to the engine 612.

The engine 612 operates in accordance with the control signals output from the actuator unit 702. The engine 612 includes a plurality of sensors, and each sensor outputs control data and environmental performance data to the control unit 701 as measurement data. The control data is data indicating the value of the control variable, and the environmental performance data is data indicating the value of the environmental performance variable.

The control unit 701 acquires the measurement data output from the engine 612 and transmits the test data including the manipulation data and the measurement data to the server 602 together with the control map.

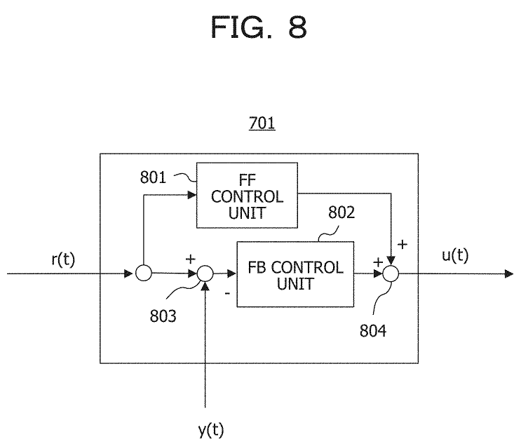

FIG. 8 illustrates a functional configuration example of the control unit 701 in FIG. 7. The control unit 701 in FIG. 8 includes a feedforward (FF) control unit 801, a feedback (FB) control unit 802, a subtraction unit 803, and an addition unit 804.

Control data y(t) represents the value of each control variable at a time t and is output to the control unit 701 from the engine 612. Target data r(t) represents a target value for y(t) and is set by the engineer E1. Furthermore, the engineer E1 sets the adjusted control map in the FF control unit 801.

The FF control unit 801 generates first partial manipulation data from r(t), using the set control map, and outputs the first partial manipulation data to the addition unit 804. The subtraction unit 803 subtracts y(t) from r(t) and outputs the subtraction result to the FB control unit 802. The FB control unit 802 generates second partial manipulation data from the subtraction result and outputs the generated second partial manipulation data to the addition unit 804.

The addition unit 804 adds the first partial manipulation data output from the FF control unit 801 and the second partial manipulation data output from the FB control unit 802 and outputs the addition result to the actuator unit 702 as manipulation data u(t). The manipulation data u(t) represents the value of each manipulated variable at the time t.

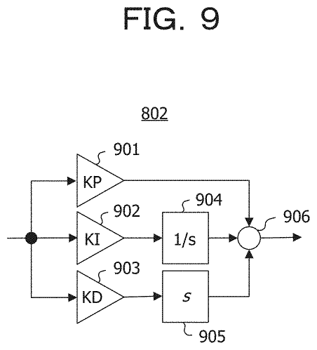

FIG. 9 illustrates a functional configuration example of the FB control unit 802 in FIG. 8. The FB control unit 802 in FIG. 9 includes multiplication units 901 to 903, an integration unit 904, a differentiation unit 905, and an addition unit 906 and generates the second partial manipulation data by proportional-integral-differential (PID) control.

The multiplication unit 901 multiplies the subtraction result output from the subtraction unit 803 by a gain KP and outputs the multiplication result to the addition unit 906. The multiplication unit 902 multiplies the subtraction result output from the subtraction unit 803 by a gain KI and outputs the multiplication result to the integration unit 904. The multiplication unit 903 multiplies the subtraction result output from the subtraction unit 803 by a gain KD and outputs the multiplication result to the differentiation unit 905. The values of KP, KI, and KD are adjusted by the engineer E1 when creating the control map.

The integration unit 904 outputs the integral value of the multiplication result output from the multiplication unit 902 to the addition unit 906. The differentiation unit 905 outputs the differential value of the multiplication result output from the multiplication unit 903 to the addition unit 906. The addition unit 906 adds the multiplication result output from the multiplication unit 901, the integral value output from the integration unit 904, and the differential value output from the differentiation unit 905 and outputs the addition result to the addition unit 804 as the second partial manipulation data.

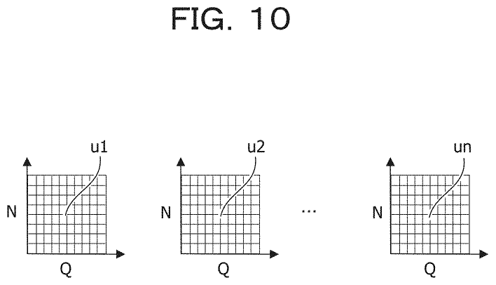

FIG. 10 illustrates an example of n (n is an integer equal to or greater than one) control maps set in the FF control unit 801 in FIG. 8. Manipulated variables u1 to un represent n manipulated variables used to control the engine 612.

The control map of each manipulated variable ui (i=1 to n) is a table representing two-dimensional distribution of the values of ui and includes the values of ui corresponding to the values of a fuel injection quantity Q and the values of rotational speed N. In this case, u1 to un are manipulated variables other than the fuel injection quantity Q. The manipulated variable ui is an example of specific manipulated variables, the fuel injection quantity Q is an example of predetermined manipulated variables, and the rotational speed N is an example of predetermined measurement object variables.

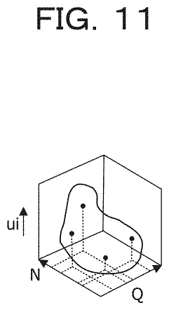

FIG. 11 illustrates an example of the control map of the manipulated variable ui in FIG. 10. The value of ui contained in the control map in FIG. 11 changes according to the value of the fuel injection quantity Q and the value of the rotational speed N.

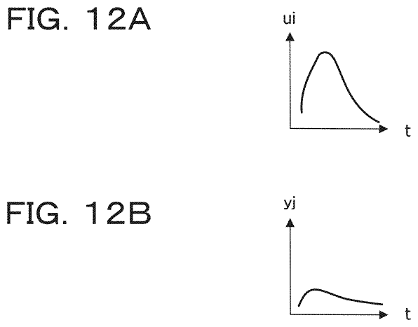

FIGS. 12A and 12B illustrate an example of the manipulation data and the control data transmitted to the server 602 from the engine test rig 601. FIG. 12A illustrates an example of the manipulation data of the manipulated variable ui. The horizontal axis represents the time t, and the vertical axis represents the value of ui. The value of ui changes with the time t.

FIG. 12B illustrates an example of the control data of the control variables yj (j=1 to m). The control variables y1 to ym represent m (m is an integer equal to or greater than one) control variables used to control the engine 612. The horizontal axis represents the time t, and the vertical axis represents the value of yj. The value of yj changes with the time t.

Similar to the control data, the environmental performance data of one or a plurality of environmental performance variables transmitted to the server 602 from the engine test rig 601 also includes the values of the environmental performance variables that change with the time t.

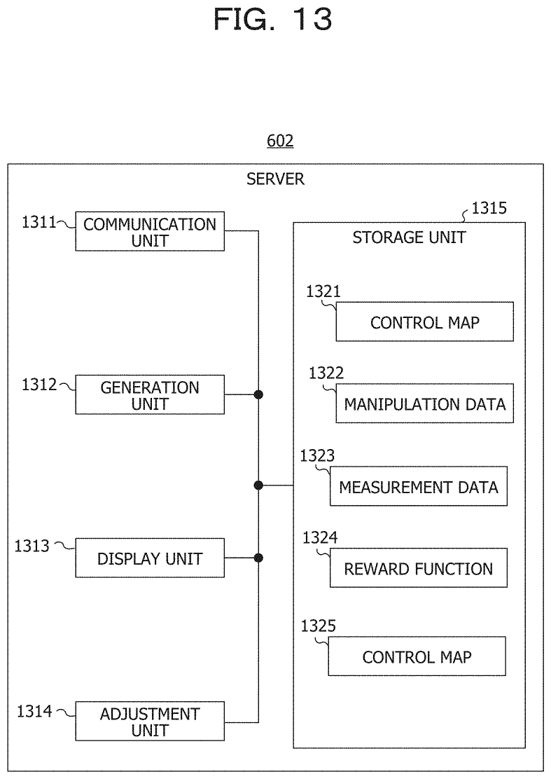

FIG. 13 illustrates a functional configuration example of the server 602 in FIG. 6. The server 602 in FIG. 13 includes a communication unit 1311, a generation unit 1312, a display unit 1313, an adjustment unit 1314, and a storage unit 1315. The communication unit 1311 and the generation unit 1312 correspond to the acquisition unit 311 and the generation unit 312 in FIG. 3, respectively. The adjustment unit 1314 is an example of a distribution information generation unit.

When the control map set in the FF control unit 801 is created by an expert, the server 602 supports an inexperienced engineer E2 in working on creating another control map.

The communication unit 1311 receives the control map and the test data from the engine test rig 601, based on an instruction from the generation unit 1312. The storage unit 1315 stores the received control map as a control map 1321 and stores the manipulation data and the measurement data included in the received test data as manipulation data 1322 and measurement data 1323, respectively.

The generation unit 1312 uses the manipulation data 1322 and the measurement data 1323 to calculate the values of p (p is an integer equal to or greater than one) evaluation indices φk (k=1 to p), thereby generating evaluation index data of φk.

As φk, for example, an index in which it is desirable to have a value of zero is used. The evaluation index φk may be the concentration of substances contained in the exhaust gas, the square of the error between the target value and the measured value of the control variable, the amount of overshoot of the measured value of the control variable relative to the target value, the rising speed of the measured value of the control variable relative to the target value, or the square of the amount of change in the manipulated variable.

For example, when φk is the square of the error between a target value rj and a measured value aj of the control variable yj, the value of φk is calculated by the following formula.

φk=|rj−aj|\hat{ }2 (1)

In addition, when φk is the square of the amount of change Dui in the manipulated variable ui, the value of φk is calculated by the following formula.

φk=|Δui|\hat{ }2 (2)

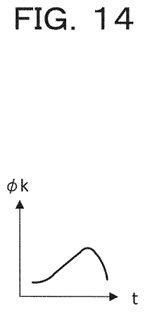

FIG. 14 illustrates an example of the evaluation index data of φk. The horizontal axis represents the time t, and the vertical axis represents the value of φk. The value of φk changes with the time t.

Next, the generation unit 1312 normalizes each evaluation index φk to obtain a normalized evaluation index ωk. For example, when one is used as the maximum value of ωk and zero is used as the minimum value of ωk, ωk is calculated by the following formula.

ωk=(φk−min(φk))/(max(φk)−min(φk)) (3)

In formula (3), the maximum value among the values of φk obtained from the manipulation data 1322 or the measurement data 1323 at each of a plurality of times is represented by max(φk), and the minimum value among these values of φk is represented by min(φk).

When zero is used as the average value of ωk and one is used as the variance of ωk, ωk is calculated by the following formula.

ωk=(φk−ave(φk))/q(φk) (4)

In formula (4), the average value of the values of φk obtained from the manipulation data 1322 or the measurement data 1323 at each of a plurality of times is represented by ave(φk), and the standard deviation of these values of φk is represented by σ(φk).

Next, by performing inverse reinforcement learning using ω1 to ωp, the generation unit 1312 generates a reward function 1324 including the weighted sum of φ1 to φp and stores the generated reward function 1324 in the storage unit 1315. The inverse reinforcement learning used to generate the reward function 1324 may be inverse reinforcement learning using linear programming, inverse reinforcement learning using the maximum entropy principle, relative entropy inverse reinforcement learning, or maximum entropy deep inverse reinforcement learning.

For example, when the control map 1321 includes n control maps representing two-dimensional distribution of ui corresponding to the fuel injection quantity Q and the rotational speed N as illustrated in FIG. 10, the reward function 1324 is represented by the following formula.

R(N,Q)=Σₖ₌₁^{p}θk(N,Q)·ϕk (5)

In formula (5), R(N, Q) corresponds to the reward function 1324. The coefficient of φk is represented by θk, and the value of θk corresponding to N and Q is represented by θk(N, Q). The value of θk represents the weight of φk included in R(N, Q) and reflects the evaluation criterion of the engineer E1 for the control map 1321.

Therefore, by obtaining R(N, Q), the evaluation criterion of the engineer E1 who created the control map 1321, for the engine 612 may be acquired. For example, when the control map 1321 is created by an expert, the value of θk reflects the evaluation criterion of the expert.

Each value of θk(N, Q) is represented using a coefficient map containing a plurality of values of θk. The coefficient map corresponds to the coefficient distribution information representing distribution of the values of coefficients of the evaluation indices.

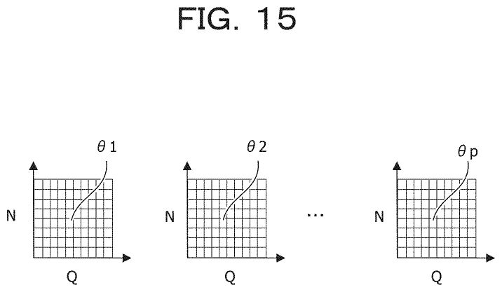

FIG. 15 illustrates an example of p coefficient maps included in R(N, Q). The coefficient map of each coefficient θk (k=1 to p) is a table representing two-dimensional distribution of the values of θk and includes the values of θk corresponding to the values of the fuel injection quantity Q and the values of the rotational speed N. The coefficient θk is an example of specific coefficients.

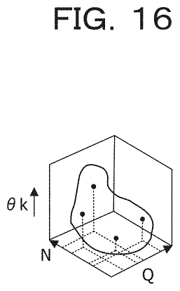

FIG. 16 illustrates an example of the coefficient map of the coefficient θk in FIG. 15. The value of θk contained in the coefficient map in FIG. 16 changes according to the value of the fuel injection quantity Q and the value of the rotational speed N. By using the coefficient map, changes in θk according to the state of the engine 612 may be expressed.

By generating the p coefficient maps illustrated in FIG. 15 using the manipulation data based on the n control maps illustrated in FIG. 10, an evaluation criterion of the engineer E1 according to the values of the fuel injection quantity Q and the rotational speed N in complicated engine control may be acquired. In addition, by using the engine-specific manipulated variables, control variables, and environmental performance variables described earlier, an appropriate reward function 1324 for the engine 612 may be generated.

Note that the combination of the predetermined manipulated variable and the predetermined measurement object variable in the control map and the coefficient map is not limited to the combination of the fuel injection quantity Q and the rotational speed N. The control map and the coefficient map may be generated using another combination of the manipulated variable and the measurement object variable.

Next, the inexperienced engineer E2 works on creating a control map 1325 for an engine ENG other than the engine 612. The engine ENG is, for example, a different model engine than the engine 612.

The engine 612 is an example of the first control object device, and the engine ENG is an example of the second control object device. The control map 1321 is an example of first manipulated variable distribution information, and the control map 1325 is an example of second manipulated variable distribution information.

First, the engineer E2 inputs n control maps as adjustment objects to the server 602. The display unit 1313 displays the reward function 1324 generated by the generation unit 1312 together with the coefficient map of each coefficient θk on a screen. Next, the engineer E2 refers to the displayed reward function 1324 and coefficient map to input an instruction to modify a value contained in the control map of each manipulated variable ui.

The adjustment unit 1314 generates the control map 1325 by adjusting the value of ui contained in the control map as an adjustment object in accordance with the input instruction and stores the generated control map 1325 in the storage unit 1315. The engineer E2 is also allowed to refer to the displayed reward function 1324 and coefficient map to adjust the values of the gain KP, the gain KI, and the gain KD for the FB control unit 802. The control map 1325 and KP, KI, and KD reflect an evaluation criterion of the expert via the reward function 1324.

By using the reward function 1324 that reflects an evaluation criterion of the expert, even the inexperienced engineer E2 is allowed to create the control map 1325 equivalent to the control map 1321 created by the expert. By referring to the reward function 1324 and the coefficient map, the engineer E2 may make judgments equivalent to the judgments of the expert, which in turn reduces man-hours for adjustment and allows to create the control map 1325 in a short period of time.

The adjustment unit 1314 may generate the control map 1325 and adjust the values of KP, KI, and KD by performing an optimization calculation instead of adjusting the control map in accordance with the instruction of the engineer E2. The optimization calculation is performed using information regarding the configurations of the engine ENG and the control device 611, and the reward function 1324.

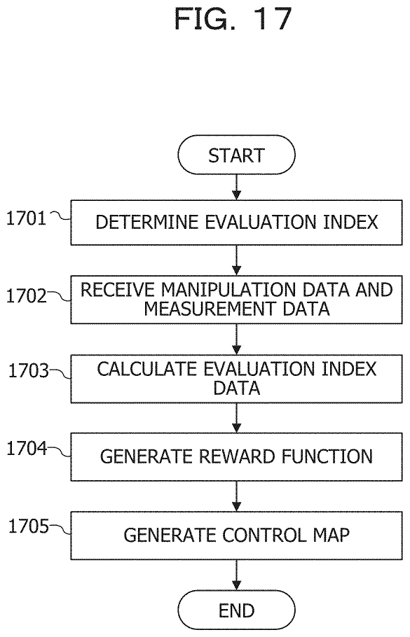

FIG. 17 is a flowchart illustrating an example of a control map adjustment process performed by the server 602 in FIG. 13. First, the engineer E1 determines an evaluation index for the control map and inputs the determined evaluation index to the server 602 (step 1701).

Next, the engine test rig 601 acquires the test data including the manipulation data and the measurement data, by performing an operation test of the engine 612 based on the control map created by the engineer E1, and transmits the acquired test data to the server 602. Then, the communication unit 1311 of the server 602 receives the manipulation data 1322 and the measurement data 1323 from the engine test rig 601 (step 1702).

Next, the generation unit 1312 calculates the evaluation index data, using the manipulation data 1322 and the measurement data 1323 (step 1703), and performs the inverse reinforcement learning using the normalized evaluation index data to generate the reward function 1324 (step 1704). Subsequently, the adjustment unit 1314 generates the control map 1325 for the engine ENG other than the engine 612, based on the generated reward function 1324 (step 1705).

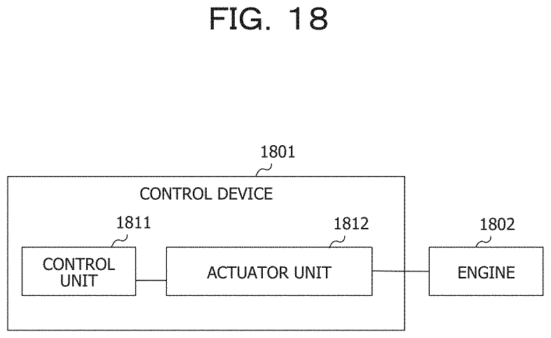

FIG. 18 illustrates a configuration example of an engine control system provided in an automobile. The engine control system in FIG. 18 includes a control device 1801 and an engine 1802. The control device 1801 includes a control unit 1811 and an actuator unit 1812 and controls the engine 1802 when the automobile runs. The control device 1801 and control unit 1811 correspond to the control device 501 and the control unit 511 in FIG. 5, respectively.

The control unit 1811 and the actuator unit 1812 are hardware. The engine 1802 corresponds to the engine ENG other than the engine 612. The control unit 1811 may control the engine 1802 with a functional configuration similar to the functional configuration of the control unit 701 in FIG. 8 or may control the engine 1802 by model predictive control.

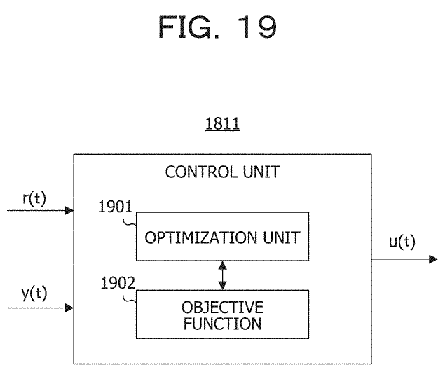

FIG. 19 illustrates a functional configuration example of the control unit 1811 that performs model predictive control. The control unit 1811 in FIG. 19 includes an optimization unit 1901. The optimization unit 1901 controls the engine 1802 by model predictive control using an objective function 1902. As the objective function 1902, for example, the reward function 1324 generated by the server 602 is used.

In the model predictive control, the optimization unit 1901 obtains the manipulation data u(t) that minimizes the objective function 1902, using the set target data r(t) and the control data y(t) output from the engine 1802. Then, the optimization unit 1901 outputs obtained u(t) to the actuator unit 1812.

The actuator unit 1812 converts u(t) output from the control unit 1811 into the control signal and outputs the control signal to the engine 1802.

When the time t is described using a discrete control time x, the objective function 1902 is represented by, for example, the following formula.

$$\begin{matrix}J ( x ) = {\sum }_{s = 0}^{h - 1} R ( N ( x + s ) , Q ( x + s ) ) \\ = {\sum }_{s = 0}^{h - 1} {\sum }_{k = 1}^{p} θ k ( N ( x + s ) , Q ( x + s ) ) \cdot ϕ k ( x + s )\end{matrix} \qquad ( 6 )$$

In formula (6), J(x) corresponds to the objective function 1902 with the control time x as a variable. The value of the rotational speed N at a control time x+s is represented by N(x+s), and the value of the fuel injection quantity Q at the control time x+s is represented by Q(x+s).

The value of R(N, Q) at the control time x+s is represented by R(N(x+s), Q(x+s)), the value of θk corresponding to N(x+s) and Q(x+s) is represented by θk(N(x+s), Q(x+s)), and the value of φk at the control time x+s is represented by φk(x+s). A prediction horizon in model predictive control is represented by h.

The value of φk(x+s) is determined depending on the values of u1 to un at the control time x+s. For example, when the value of φk is calculated by formula (1), φk(x+s) is calculated by the following formula.

φk(x+s)=|rj(x+s)−aj(x+s)|\hat{ }2 (7)

In formula (7), the value of rj at the control time x+s is represented by rj(x+s), and the value of aj at the control time x+s is represented by aj(x+s). The value of aj changes depending on the values of u1 to un.

In addition, when the value of φk is calculated by formula (2), φk(x+s) is calculated by the following formula.

φk=|Δui(x+s)|\hat{ }2 (8)

In formula (8), the value of ui at the control time x+s is represented by ui(x+s).

According to the engine control system in FIG. 18, an evaluation criterion of the expert who created the control map 1321 for the engine 612 may be acquired and used for controlling the engine 1802. At this time, by using the reward function 1324 as the objective function 1902, model predictive control that reflects an evaluation criterion of the expert is implemented.

The configuration of the engine test rig in FIG. 1 is merely an example, and some components may be omitted or modified according to the use or conditions of the engine test rig. The configurations of the function generation device 301 in FIG. 3 and the control device 501 in FIG. 5 are merely examples, and some components may be omitted or modified according to the use or conditions of the function generation device 301 or the control device 501.

The configurations of the engine control systems in FIGS. 6 and 18 are merely examples, and some components may be omitted or modified according to the use or conditions of the engine control systems. The configurations of the control device 611 in FIG. 7, the control unit 701 in FIG. 8, the FB control unit 802 in FIG. 9, and the server 602 in FIG. 13 are merely examples, and some components may be omitted or modified according to the use or conditions of the engine control system. For example, in the server 602 in FIG. 13, the adjustment unit 1314 may be omitted when the control map 1325 does not have to be generated.

The configuration of the control unit 1811 in FIG. 19 is merely an example, and some components may be omitted or modified according to the use or conditions of the engine control system.

The flowcharts in FIGS. 4 and 17 are merely examples, and some processes may be omitted or modified according to the configuration or conditions of the function generation device 301 or the engine control systems. For example, in the control map adjustment process in FIG. 17, the process in step 1705 may be omitted when the control map 1325 does not have to be generated.

The problems illustrated in FIGS. 2A and 2B are merely examples, and a similar problem sometimes arises also when an engineer other than an expert or an inexperienced engineer creates the control map.

The control maps illustrated in FIGS. 10 and 11 are merely examples, and the control maps change according to the design intentions of the engineer. The control map may be created using a combination of the manipulated variable and the measurement object variable other than the fuel injection quantity Q and the rotational speed N. The coefficient maps illustrated in FIGS. 15 and 16 are merely examples, and the coefficient maps change according to the control map.

The manipulation data and the control data illustrated in FIGS. 12A and 12B are merely examples, and the manipulation data and the control data change according to the control object device. The evaluation index data illustrated in FIG. 14 is merely an example, and the evaluation index data changes according to the manipulation data and the measurement data.

Formulas (1) to (6) are merely examples, and the server 602 may use other calculation formulas to perform the control map adjustment process. Formulas (7) and (8) are merely examples, and the control device 1801 may use other calculation formulas to perform the model predictive control.

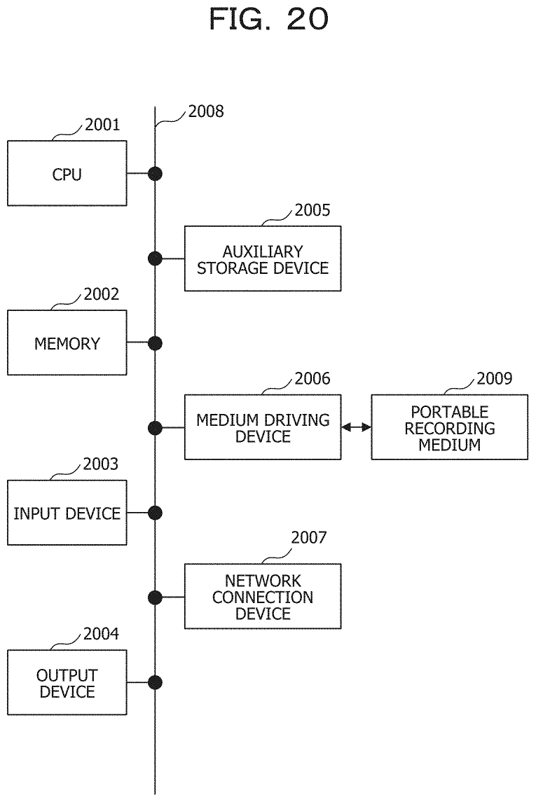

FIG. 20 illustrates a hardware configuration example of an information processing device (computer) used as the function generation device 301 in FIG. 3 and the server 602 in FIG. 13. The information processing device in FIG. 20 includes a central processing unit (CPU) 2001, a memory 2002, an input device 2003, an output device 2004, an auxiliary storage device 2005, a medium driving device 2006, and a network connection device 2007. These components are hardware and are connected to each other by a bus 2008.

The memory 2002 is, for example, a semiconductor memory such as a read only memory (ROM) or a random access memory (RAM) and stores programs and data to be used for processes.

The memory 2002 may operate as the storage unit 1315 in FIG. 13.

The CPU 2001 (processor) operates as the generation unit 312 in FIG. 3 by, for example, executing a program using the memory 2002. The CPU 2001 also operates as the generation unit 1312 and the adjustment unit 1314 in FIG. 13 by executing a program using the memory 2002.

For example, the input device 2003 is a keyboard, a pointing device, or the like and is used for inputting instructions or information from a user or an operator. For example, the output device 2004 is a display device, a printer, or the like and is used for an inquiry or an instruction to the user or the operator, and an output of a processing result. The processing result may be the reward function 1324, the coefficient map, or the control map 1325. The output device 2004 may operate as the display unit 1313 in FIG. 13.

For example, the auxiliary storage device 2005 is a magnetic disk device, an optical disk device, a magneto-optical disk device, a tape device, or the like. The auxiliary storage device 2005 may be a hard disk drive. The information processing device may store programs and data in the auxiliary storage device 2005 and load these programs and data into the memory 2002 to use. The auxiliary storage device 2005 may operate as the storage unit 1315 in FIG. 13.

The medium driving device 2006 drives a portable recording medium 2009 and accesses the contents recorded in the portable recording medium 2009. The portable recording medium 2009 is a memory device, a flexible disk, an optical disk, a magneto-optical disk, or the like. The portable recording medium 2009 may be a compact disk read only memory (CD-ROM), a digital versatile disk (DVD), a universal serial bus (USB) memory, or the like. The user or the operator may store the programs and data in the portable recording medium 2009 and load these programs and data into the memory 2002 to use.

As described above, a computer-readable recording medium in which the programs and data to be used for processes are stored is a physical (non-transitory) recording medium such as the memory 2002, the auxiliary storage device 2005, or the portable recording medium 2009.

The network connection device 2007 is a communication interface circuit that is coupled to a communication network such as a local area network (LAN) or a wide area network (WAN) and performs data conversion associated with communication. The information processing device may receive programs and data from an external device via the network connection device 2007 and load these programs and data into the memory 2002 to use. The network connection device 2007 may operate as the acquisition unit 311 in FIG. 3 or the communication unit 1311 in FIG. 13.

Note that the information processing device does not have to include all the components in FIG. 20, and some components may be omitted according to the use or conditions of the information processing device. For example, when an interface with the user or the operator is not desired, the input device 2003 and the output device 2004 may be omitted. When the portable recording medium 2009 or the communication network is not used, the medium driving device 2006 or the network connection device 2007 may be omitted.

As the hardware of the control unit 701 in FIG. 8, for example, a CPU is used. In this case, the CPU operates as the FF control unit 801, the FB control unit 802, the subtraction unit 803, and the addition unit 804 by executing a program. For example, a CPU is also used as the hardware of the control unit 1811 in FIG. 19. In this case, the CPU operates as the optimization unit 1901 by executing a program.

While the disclosed embodiment and the advantages thereof have been described in detail, those skilled in the art will be able to make various modifications, additions, and omissions without departing from the scope of the embodiment as explicitly set forth in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a function generation program for causing a computer to execute a process, the process comprising:
acquiring manipulation data generated based on manipulated variable distribution information that represents distribution of values of manipulated variables, and measurement data measured when a control object device is controlled based on the manipulation data; and
by performing inverse reinforcement learning by using the manipulation data and the measurement data, generating a reward function that includes evaluation indices for the manipulated variable distribution information and coefficient distribution information that represents distribution of the values of coefficients of the evaluation indices.

2. The non-transitory computer-readable recording medium according to claim 1, wherein
the manipulated variable distribution information represents distribution of the values for each of a plurality of manipulated variables that include the manipulated variables,
the manipulation data includes data for each of the plurality of manipulated variables,
the measurement data includes data for each of a plurality of measurement object variables,
distribution of values of a specific manipulated variable among the plurality of manipulated variables includes the values of the specific manipulated variable that correspond to values of a predetermined manipulated variable other than the plurality of manipulated variables and values of a predetermined measurement object variable among the plurality of measurement object variables,
the reward function includes a weighted sum of a plurality of evaluation indices that include the evaluation indices,
the coefficient distribution information represents distribution of values of respective coefficients of the plurality of evaluation indices, and
distribution of values of a specific coefficient among the respective coefficients of the plurality of evaluation indices includes the values of the specific coefficient that correspond to the values of the predetermined manipulated variable and the values of the predetermined measurement object variable.

3. The non-transitory computer-readable recording medium according to claim 2, wherein
the control object device is an engine,
each of the plurality of manipulated variables is a fuel injection quantity, a fuel injection pressure, a fuel injection timing, an exhaust gas recirculation opening, a turbo opening, or an intake valve opening, and
each of the plurality of measurement object variables is rotational speed, torque, a boost pressure, an intake air flow rate, or concentration of substances contained in exhaust gas.

4. The non-transitory computer-readable recording medium according to claim 1, wherein
the control object device is a first control object device,
the manipulated variable distribution information is first manipulated variable distribution information, and
the process further comprises:
generating, for a second control object device different from the first control object device, second manipulated variable distribution information that represents distribution of respective values of the manipulated variables based on the reward function.

5. An information processing device, comprising:
a memory; and
a processor coupled to the memory and the processor configured to:
acquire manipulation data generated based on manipulated variable distribution information that represents distribution of values of manipulated variables, and measurement data measured when a control object device is controlled based on the manipulation data; and
by performing inverse reinforcement learning by using the manipulation data and the measurement data, generate a reward function that includes evaluation indices for the manipulated variable distribution information and coefficient distribution information that represents distribution of the values of coefficients of the evaluation indices.

6. The information processing device according to claim 5, wherein
the manipulated variable distribution information represents distribution of the values for each of a plurality of manipulated variables that include the manipulated variables,
the manipulation data includes data for each of the plurality of manipulated variables,
the measurement data includes data for each of a plurality of measurement object variables,
distribution of values of a specific manipulated variable among the plurality of manipulated variables includes the values of the specific manipulated variable that correspond to values of a predetermined manipulated variable other than the plurality of manipulated variables and values of a predetermined measurement object variable among the plurality of measurement object variables,
the reward function includes a weighted sum of a plurality of evaluation indices that include the evaluation indices,
the coefficient distribution information represents distribution of values of respective coefficients of the plurality of evaluation indices, and
distribution of values of a specific coefficient among the respective coefficients of the plurality of evaluation indices includes the values of the specific coefficient that correspond to the values of the predetermined manipulated variable and the values of the predetermined measurement object variable.

7. The information processing device according to claim 6, wherein
the control object device is an engine,
each of the plurality of manipulated variables is a fuel injection quantity, a fuel injection pressure, a fuel injection timing, an exhaust gas recirculation opening, a turbo opening, or an intake valve opening, and
each of the plurality of measurement object variables is rotational speed, torque, a boost pressure, an intake air flow rate, or concentration of substances contained in exhaust gas.

8. The information processing device according to claim 5, wherein
the control object device is a first control object device,
the manipulated variable distribution information is first manipulated variable distribution information, and
the processor is further configured to:
generate, for a second control object device different from the first control object device, second manipulated variable distribution information that represents distribution of respective values of the manipulated variables based on the reward function.

9. The information processing device according to claim 5, wherein
the processor is further configured to:
control, by model predictive control that uses the reward function, another control object device different from the control object device.

10. A function generation method, comprising:
acquiring, by a computer, manipulation data generated based on manipulated variable distribution information that represents distribution of values of manipulated variables, and measurement data measured when a control object device is controlled based on the manipulation data; and
by performing inverse reinforcement learning by using the manipulation data and the measurement data, generating a reward function that includes evaluation indices for the manipulated variable distribution information and coefficient distribution information that represents distribution of the values of coefficients of the evaluation indices.

11. The function generation method according to claim 10, wherein
the manipulated variable distribution information represents distribution of the values for each of a plurality of manipulated variables that include the manipulated variables,
the manipulation data includes data for each of the plurality of manipulated variables,
the measurement data includes data for each of a plurality of measurement object variables,
distribution of values of a specific manipulated variable among the plurality of manipulated variables includes the values of the specific manipulated variable that correspond to values of a predetermined manipulated variable other than the plurality of manipulated variables and values of a predetermined measurement object variable among the plurality of measurement object variables,
the reward function includes a weighted sum of a plurality of evaluation indices that include the evaluation indices,
the coefficient distribution information represents distribution of values of respective coefficients of the plurality of evaluation indices, and
distribution of values of a specific coefficient among the respective coefficients of the plurality of evaluation indices includes the values of the specific coefficient that correspond to the values of the predetermined manipulated variable and the values of the predetermined measurement object variable.

12. The function generation method according to claim 11, wherein
the control object device is an engine,
each of the plurality of manipulated variables is a fuel injection quantity, a fuel injection pressure, a fuel injection timing, an exhaust gas recirculation opening, a turbo opening, or an intake valve opening, and
each of the plurality of measurement object variables is rotational speed, torque, a boost pressure, an intake air flow rate, or concentration of substances contained in exhaust gas.

13. The function generation method according to claim 10, wherein
the control object device is a first control object device,
the manipulated variable distribution information is first manipulated variable distribution information, and
the method further comprises:
generating, for a second control object device different from the first control object device, second manipulated variable distribution information that represents distribution of respective values of the manipulated variables based on the reward function.
